(19) United States
(12) Patent Application Publication
(10) Pub. No.: US 2016/0019306 A1
(43) Pub. Date: Jan. 21, 2016

(54) LINK PREVIEW MANAGEMENT

(71) Applicant: Empire Technology Development LLC, Wilmington, DE (US)

(72) Inventor: Yang-Won JUNG, Seoul (KR)

(21) Appl. No.: 14/334,906

(22) Filed: Jul. 18, 2014

(51) Int. Cl. G06F 17/30; H04L 29/08

(52) U.S. Cl. CPC G06F 17/30882; H04L 67/02

(57) ABSTRACT

Technologies are generally described for a link preview generation scheme. In some examples, a method performed under control of a user device may include obtaining preview information associated with a link included in an electronic message; generating at least one link loading attribute regarding the link based on, at least in part, the preview information; and displaying the at least one link loading attribute on a display unit of the user device.

### BACKGROUND

User devices such as, for example, a desktop computer, a laptop computer, a smartphone, a mobile phone or a tablet may provide a user access to a network, such as the Internet. Such a user device may receive, from a server through the network, an electronic message including at least one link, which is associated with a content server (which may correspond to the server or another server). When a user of the user device clicks a link included in the electronic message, which is displayed on the user device, the user device may connect to the content server to load data including a text, an image, a movie clip, etc.

### SUMMARY

In an example, a method performed under control of a user device may include obtaining preview information associated with a link included in an electronic message; generating at least one link loading attribute regarding the link based on, at least in part, the preview information; and displaying the at least one link loading attribute on a display unit of the user device.

In another example, a user device may include a receiver unit configured to receive an electronic message; a link management unit configured to obtain preview information associated with a link included in the received electronic message; a link loading attribute generation unit configured to generate at least one link loading attribute regarding the link based on, at least in part, the preview information; and a display unit configured to display the at least one link loading attribute.

In yet another example, a computer-readable storage medium may store thereon computer-executable instructions that, in response to execution, cause a user device to perform operations, including identifying a link from an electronic message; receiving a data file from a content server associated with the link; determining preview information based on, at least in part, the received data file; generating at least one link loading attribute regarding the link based on, at least in part, the determined preview information; and displaying the generated at least one link loading attribute on a display unit of the user device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows an example of an environment in which a user device may communicate with a content server and/or a search engine server, arranged in accordance with at least some embodiments described herein;

FIG. 2 shows a block diagram of an example architecture of a user device configured to implement link preview management, arranged in accordance with at least some embodiments described herein;

FIG. 3 shows a block diagram of another example architecture of a user device to implement link preview management, arranged in accordance with at least some embodiments described herein;

FIG. 4 shows a block diagram of an example architecture of a link preview manager to implement link preview management, arranged in accordance with at least some embodiments described herein;

FIG. 5 shows an example flow diagram of a process to implement link preview management, arranged in accordance with at least some embodiments described herein;

FIG. 6 shows another flow diagram of a process to implement link preview management, arranged in accordance with at least some embodiments described herein;

FIGS. 7A to 7C show examples that one or more link loading attributes are displayed on a display unit of a user device, arranged in accordance with at least some embodiments described herein;

FIG. 8 illustrates an example computer program product that may be utilized to implement link preview management, arranged in accordance with at least some embodiments described herein; and

FIG. 9 is a block diagram illustrating an example computing device that may be utilized to implement link preview management, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to link preview management.

In some examples, a user device may be configured to identify a link included in an electronic message and obtain preview information associated with the link. The electronic message may include, but not limited to, a web page, an e-mail, a document file, or any type of message that may be transmitted from a server and/or other user device.

The user device may be configured to receive a data file, to which the link is directed, from a content sever and to obtain the preview information based on the received data file. Additionally and/or alternatively, the user device may be configured to receive, from a search engine server, the preview information associated with the link. In such cases, the search engine server may be configured to previously collect the preview information associated with the link and provide the preview information to the user device upon receiving a request from the user device.

By way of example, but not limitation, the preview information may include information regarding data content associated with the link. The information may include, for example, a categorization of the data content, e.g., audio files and/or video files accessible by the link; a quantity of each category of the data content, e.g., a number of audio files accessible by the link; or a size of each of the data content, e.g., a size of each audio file accessible by the link.

The user device may be configured to generate at least one link loading attribute regarding the link based on the preview information and display the generated at least one link loading attribute on a display unit of the user device. Although it is described that the user device performs the above described operations, actions, steps, or etc., those skilled in the art would appreciate that the above described operations, actions, steps or etc. may be performed by an application (such as, for example, a link preview manager) running on the user device. The at least one link loading attribute displayed on the display unit may then provide a user of the user device with an opportunity to determine whether or not to access the link, the user of the user device having been provided with information such as, but not limited to, the size of the files that are accessible by the link, included in the link loading attribute.

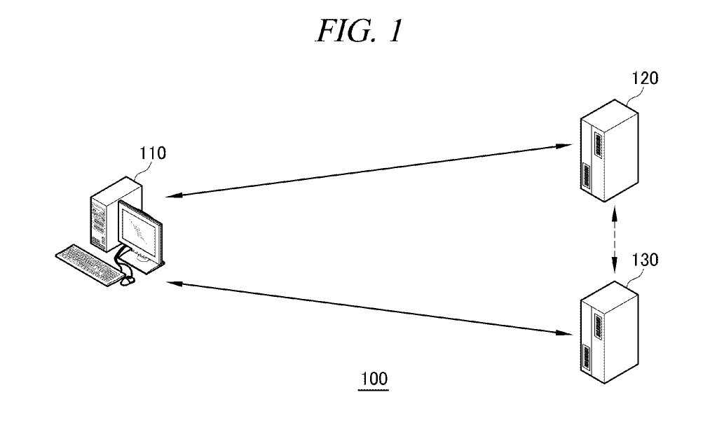

FIG. 1 shows an example of an environment in which a user device 110 may communicate with a content server 120 and/or a search engine server 130, arranged in accordance with at least some embodiments described herein.

As depicted, user device 110 may be communicatively coupled to content server 120 and/or search engine server 130 over a network such as, for example, a wireless network, a cellular network, a wide area network (WAN), a metropolitan area network (MAN), a local area network (LAN), a campus area network (CAN), a virtual private network (VPN), etc. User device 110 may be any type of client device configured to receive, calculate, store and/or display data, which may include an electronic message such as, for example, a web page, an e-mail message, an application, a page of a Social Network Service (SNS) or a message of Short Message Service (SMS). By way of example, but not limitation, user device 110 may include a smartphone, a mobile phone, a personal digital assistant (PDA), a tablet, a hybrid of the aforementioned devices, a personal computer such as a laptop computer or a desktop computer, etc.

In some embodiments, user device 110 may be configured to receive, from content server 120 or another device (not shown) such as, for example, another server device or another user device, an electronic message that includes a link associated with content server 120. By way of example, but not limitation, the link included in the electronic message may include a hyperlink that is directed to a content file such as, for example, another electronic message stored in content server 120. User device 110 may display the received electronic message on its display unit.

In some embodiments, user device 110 may be configured to obtain preview information associated with the link included in the electronic message. In some examples, user device 110 may be configured to transmit, to content server 120, a request for a data file regarding the link. User device 110 may then be configured to receive the data file from content server 120 and obtain the preview information based on the received data file. By way of example, but not limitation, the data file may include a Hyper-Text Mark-up Language (HTML) file, a Document Object Model (DOM) file, a JAVA script file, etc. In some embodiments, user device 110 may be configured to extract, from the received data file, one or more parameters regarding data content (such as, for example, text data, image data, audio data, video data, program data, etc.); and calculate the preview information from the extracted parameters.

Additionally and/or alternatively, user device 110 may be configured to send, to search engine server 130, a request for preview information associated with the link included in the electronic message; and to receive the preview information from search engine server 130. In such cases, search engine server 130 may be configured to collect the preview information associated with the link and provide the preview information to user device 110 upon receiving the request for preview information from user device 110.

In some embodiments, in order to previously collect the preview information, search engine server 130 may be configured to transmit, to content server 120, a request for the data file regarding the link; receive the data file from content server 120; and obtain the preview information based on the received data file. By way of example, but not limitation, the data file may include an HTML file, a DOM file, a JAVA script file, etc. In some examples, search engine server 130 may be configured to extract, from the received data file, one or more parameters regarding data content (such as, for example, text data, image data, audio data, video data, program data, etc.); and calculate the preview information from the extracted parameters. Search engine server 130 may be configured to transmit, to user device 110, the preview information, which has been previously collected, upon receiving the request for preview information from user device 110. Additionally or alternatively, search engine server 130 may also be configured to further receive, from content server 120, all or some of the data content concurrently with or separately from receiving of the data file; and to calculate the preview information using the received data content.

In some embodiments, the preview information may include information regarding data content associated with the link. By way of example, but not limitation, the data content may include at least one of text data, image data, video data, audio data or program data, which may be viewed by or downloaded to user device 110 when user device 110 connects to content server 120 through the link. For example, when a user of user device 110 clicks on the link that is displayed on the display unit of user device 110, user device 110 may connect to content server 120 using network address information of content server 120 included in the link to access the data content. The preview information may include information regarding data content associated with the link. The information may include, for example, a categorization of the data content, e.g., audio files and/or video files; a quantity of each category of the data content, e.g., a number of audio files accessible by the link; or a size of each of the data content, e.g., a size of each audio file accessible by the link.

In some embodiments, the preview information may include a processing time or a routing time of content server 120 associated with the link. By way of example, but not limitation, the processing time of content server 120 may indicate an amount of time needed for content server 120 to process a request regarding the data content by user device 110 (e.g., an amount of time to process a download request of the data content in content server 120), and the routing time of content server 120 may indicate an amount of time that is taken for routing to content server 120. Content server 120 may provide user device 110 with such time information, for example, when transmitting the data file regarding the link to user device 110. The processing time or the routing time may then be used for user device 110 to generate an estimated loading time of the link, as will be described below.

In some embodiments, user device 110 may be configured to generate at least one link loading attribute regarding the link based on the preview information. By way of example, but not limitation, the at least one link loading attribute may include at least one of a total amount of content data associated with the link, an estimated loading time of the link, a representative type of content data associated with the link (for example, a text centric type, an image centric type, a video centric type, etc.), battery related information (for example, estimated battery capacity of user device 110 to be remained and/or consumed by loading the link), or an estimated service data packets to be remained or consumed by loading the link. In some embodiments, user device 110 may be further configured to generate the at least one link loading attribute based on at least one network attribute of the network between user device 110 and content server 120 such as, for example, a network speed of the network, and/or, at least one device attribute of user device 110 such as, for example, a size of the display unit of user device 110, a network connectivity of user device 110, remaining battery capacity of user device 110, remaining service data packets which are provided by a common carrier, etc.

In some embodiments, user device 110 may generate the estimated loading time based, at least in part, on at least one of the preview information, the network attribute of the network or the device attribute of user device 110. By way of example, but not limitation, user device 110 may generate the estimated loading time by dividing the total amount of content data by the network speed. Further, user device 110 may take account of the processing time and/or the routing time of content server 120 to generate the estimated loading time.

In some embodiments, user device 110 may be configured to display the at least one link loading attribute on the display unit of user device 110. User device 110 may be configured to determine how to display the at least one link loading attribute on the display unit of user device 110 based on the preview information and/or the at least one device attribute of user device 110. In some examples, user device 110 may be configured to display, on the display unit, the at least one link loading attribute as a text message, a graphical icon, etc. Further, user device 110 may be configured to display the at least one link loading attribute as being superimposed on the electronic message that is displayed on the display unit of user device 110. By way of examples, but not limitation, the at least one link loading attribute may be located proximate to the link on the electronic message.

In some other examples, the at least one link loading attribute may be represented as a color of the link. By way of example, but not limitation, when the amount of content data associated with the link is relatively more than others or the estimated loading time associated with the link is relatively longer than others, the color of the link may be changed, for example, from blue to red.

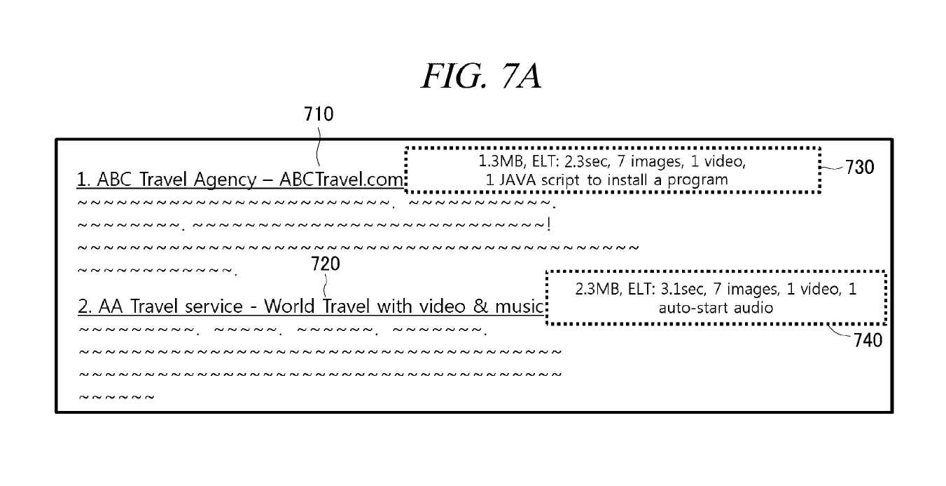

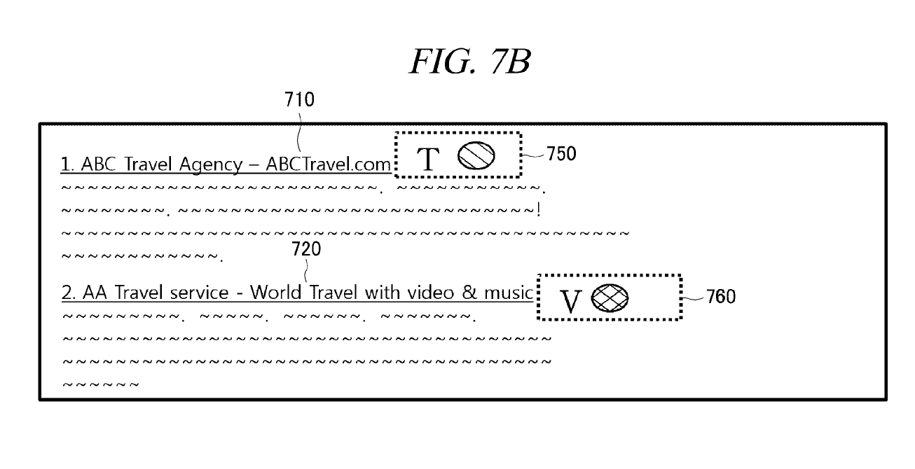

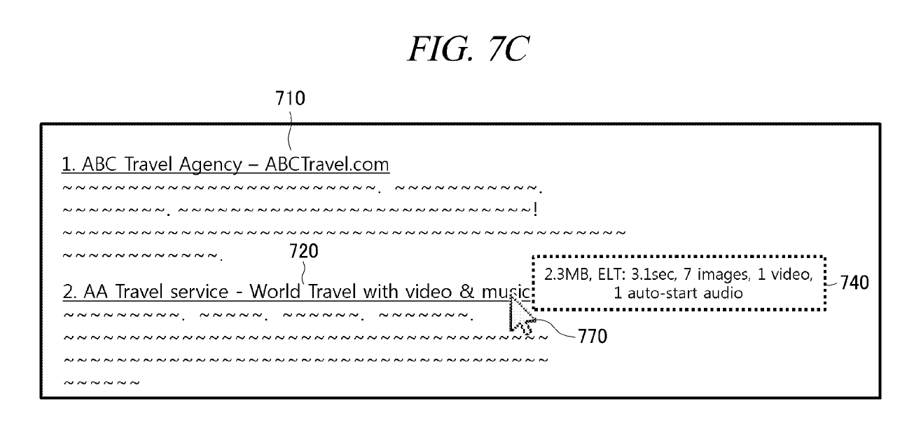

In some embodiments, user device 110 may be operated with a pointing device (such as, for example, a mouse), and user device 110 may be configured to display the at least one link loading attribute when a pointer of the pointing device is moved over the link on the display unit. Various examples regarding generating and displaying the link loading attribute will be described in more details with reference to FIGS. 7A-7C below.

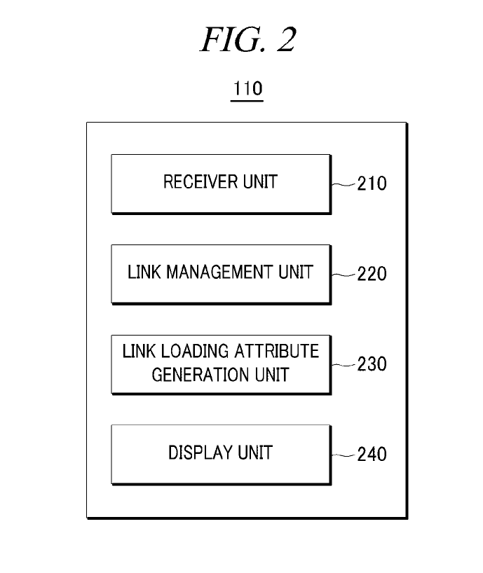

FIG. 2 shows a block diagram of an example architecture of user device 110 configured to implement link preview management, arranged in accordance with at least some embodiments described herein. Reference may be made to the embodiments depicted and described with reference to FIG. 1.

As depicted, user device 110 may include a receiver unit 210, a link management unit 220, a link loading attribute generation unit 230 and a display unit 240. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Receiver unit 210 may be configured to receive, from a content server (such as, for example, content server 120) or another entity (such as another server or other user device), an electronic message that includes a link associated with the content server. By way of example, but not limitation, the electronic message may include a web page, an e-mail message, an application, a page of an SNS or a SMS message, and the link included in the electronic message may include a hyperlink that is directed to a content file such as, for example, another electronic message stored in the content server.

Link management unit 220 may be configured to obtain preview information associated with the link included in the received electronic message. In some embodiments, user device 110 may be configured to transmit, to the content server, a request for a data file regarding the link. By way of example, but not limitation, the data file may include a HTML file, a DOM file, a JAVA script file, etc. Receiver unit 210 may then be configured to receive the data file from the content server associated with the link, and link management unit 220 may be configured to obtain and/or determine the preview information based on the received data file.

In some embodiments, link management unit 220 may be configured to extract, from the received data file, one or more parameters regarding data content (such as, for example, text data, image data, audio data, program data, etc.) associated with the link. By way of examples, but not limitation, the one or more parameters may include file extensions (for example, txt, jpg, raw, avi, mpg, mp3, wav, etc.) or command headers regarding the data content. Link management unit 220 may then be configured to calculate the preview information based on the extracted parameters.

Additionally and/or alternatively, receiver unit 220 may be configured to receive the preview information from a search engine server (such as, for example, search engine server 130). In such cases, the search engine server may be configured to collect the preview information associated with the link and provide the preview information to user device 110. In some examples, the search engine server may have determined the preview information associated with the link beforehand by, for example, receiving, from the content server, the data file associated with the link; extracting the one or more parameters regarding the data content associated with the link; and calculating the preview information from the extracted parameters. The search engine server may be configured to transmit the preview information associated with the link to receiver unit 220 upon receiving a request from user device 110.

In some embodiments, the preview information may include information regarding data content associated with the link. By way of example, but not limitation, the data content may include at least one of text data, image data, video data, audio data or program data, which may be viewed on user device 110 or downloaded by receiver unit 220 when user device 110 connects to the content server through the link. For example, when a user of user device 110 clicks on the link that is displayed on display unit 240, user device 110 may connect to the content server using network address information of the content server included in the link to access the data content. By way of example, but not limitation, the preview information may include information regarding data content associated with the link. The information may include, for example, a categorization of the data content, e.g., audio files and/or video files; a quantity of each category of the data content, e.g., a number of audio files accessible by the link; or a size of each of the data content, e.g., a size of each audio file accessible by the link. The preview information may also include a processing time or a routing time of the content server associated with the link. By way of example, but not limitation, the processing time of the content server may indicate an amount of time needed for the content server to process a request regarding the data content by user device 110 (e.g., an amount of time to process a download request of the data content in the content server), and the routing time of the content server may indicate an amount of time that is taken for routing to the content server. The content server may provide user device 110 with such time information, for example, when transmitting the data file regarding the link to user device 110. The processing time or the routing time may then be used for link loading attribute generation unit 230 to generate an estimated loading time of the link.

Link loading attribute generation unit 230 may be configured to generate at least one link loading attribute regarding the link based on the preview information. By way of example, but not limitation, the at least one link loading attribute may include at least one of a total amount of content data associated with the link (for example, total required storage space, total number of image, video, audio or JAVA script, etc.), an estimated loading time of the link or a representative type of content data associated with the link (for example, text centric type, image centric type, video centric type, etc.). In some embodiments, link loading attribute unit 230 may be further configured to generate the at least one link loading attribute based on at least one network attribute of a network between user device 110 and the content server such as, for example, a network speed of the network, and/or, at least one device attribute of user device 110, such as, for example, a size of display unit 240 of user device 110, a network connectivity of user device 110, remaining battery capacity of user device 110, remaining service data packets which are provided by a common carrier, etc.

In some embodiments, link loading attribute generation unit 230 may generate the estimated loading time based, at least in part, on at least one of the preview information, the network attribute of the network or the device attribute of user device 110. By way of example, but not limitation, link loading attribute generation unit 230 may generate the estimated loading time by dividing the total amount of content data by the network speed. Further, link loading attribute generation unit 230 may take account of the processing time and/or the routing time of the content server to generate the estimated loading time.

Display unit 240 may be configured to display the at least one link loading attribute generated by link loading attribute generation unit 230. Link loading attribute generation unit 230 may be configured to determine how to display the at least one link loading attribute on display unit 240 based on the preview information and/or the at least one device attribute of user device 110.

In some examples, the at least one link loading attribute may be determined to be displayed, on display unit 240, as a text message, a graphical icon, etc. Further, link loading attribute generation unit 230 may be configured to determine at least one position on display unit 240 in which to display the generated at least one link loading attribute. Display unit 240 may be further configured to display the at least one link loading attribute as being superimposed on the electronic message that is displayed on display unit 240. By way of examples, but not limitation, the at least one link loading attribute may be located proximate to the link on the electronic message.

In some other examples, the at least one link loading attribute may be represented as a color of the link. By way of example, but not limitation, when the amount of content data associated with the link is relatively more than others or the estimated loading time associated with the link is relatively longer than others, the color of the link may be changed, for example, from blue to red.

In some embodiments, user device 110 may be operated with a pointing device (such as, a mouse), and display unit 240 may be configured to display the at least one link loading attribute when a pointer of the pointing device is moved over the link on display unit 240.

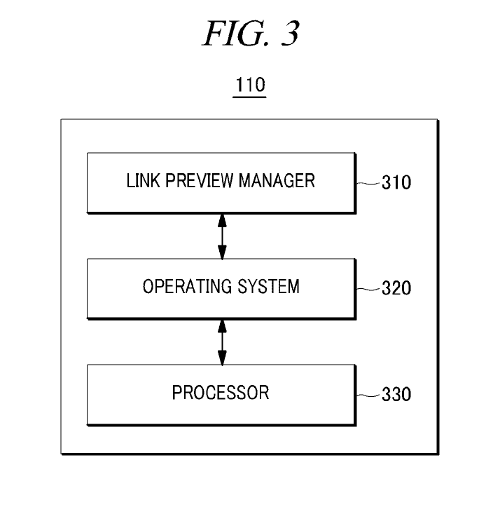

FIG. 3 shows a block diagram of another example architecture of user device 110 to implement link preview management, arranged in accordance with at least some embodiments described herein. Reference may be made to the embodiments depicted and described with reference to FIGS. 1 to 2.

As depicted, user device 110 may include a link preview manager 310, an operating system 320 and a processor 330. Link preview manager 310 may be adapted to operate on operating system 320 such that the link loading attribute generation scheme, as described herein, may be provided. Operating system 320 may allow link preview manager 310 to manipulate processor 330 to implement the link loading attribute generation scheme as described herein.

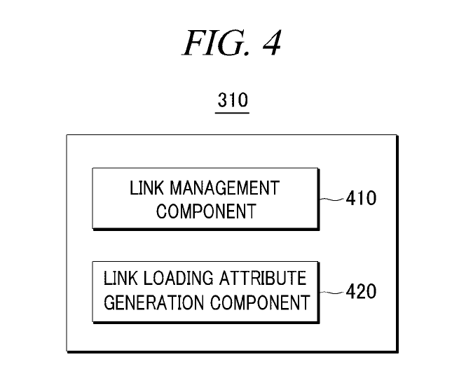

FIG. 4 shows a block diagram of example architecture of link preview manager 310 to implement link preview management, arranged in accordance with at least some embodiments described herein. Reference may be made to the embodiments depicted and described with reference to FIGS. 1 to 3.

As depicted, link preview manager 310 may include a link management component 410 and a link loading attribute generation component 420. Link management component 410 may be adapted to obtain preview information associated with a link included in an electronic message in accordance with various example methods as described above. Further, link loading attribute generation component 420 may be adapted to generate at least one link loading attribute regarding the link based on the preview information, and various example methods described above may be utilized in the generation of the at least one link loading attribute.

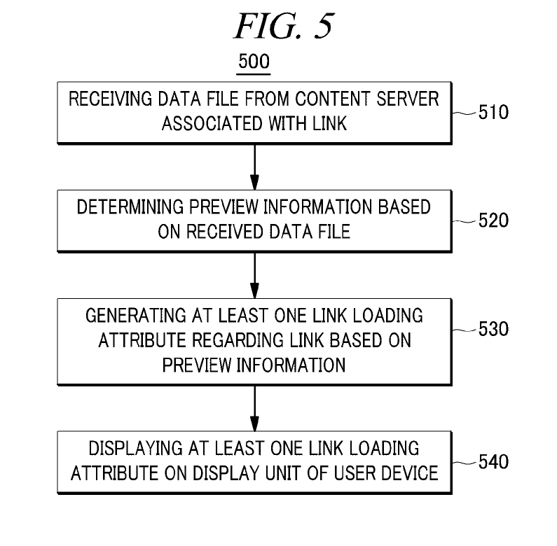

FIG. 5 shows an example flow diagram of a process to implement link preview management, arranged in accordance with at least some embodiments described herein.

Process 500 may be implemented in a user device such as user device 110 including at least some of receiving unit 210, link management unit 220, link loading attribute generation unit 230 or display unit 240. Process 500 may also be implemented by computer programs or program modules that may be adapted to provide a link loading attribute generation scheme and hosted by user device 110, such as link preview manager 310 including link management component 410 and link loading attribute generation component 420. Thus reference may be made to the embodiments depicted and described with reference to FIGS. 1-4. Process 500 may include one or more operations, actions, or functions as illustrated by one or more blocks 510, 520, 530 and/or 540. Although illustrated as discrete blocks, various blocks may be divided into additional blocks, combined into fewer blocks, or eliminated, depending on the desired implementation. Processing may begin at block 510.

At block 510 (Receiving Data File from Content Server associated with Link), user device 110 and/or receiver unit 210 may receive a data file from a content server associated with a link included in an electronic message. By way of example, but not limitation, the data file may include a HTML file, a DOM file, a JAVA script file, etc. Processing may continue from block 510 to block 520.

At block 520 (Determining Preview Information based on Received Data File), user device 110 and/or link preview manager 310 may extract and calculate preview information based on the received data file. The preview information may include information regarding data content associated with the link. In some examples, user device 110 and/or link preview manager 310 may be configured to extract, from the received data file, one or more parameters regarding data content (such as, for example, text data, image data, audio data, program data, etc.) associated with the link; and calculate the preview information from the extracted parameters. Processing may continue from block 520 to block 530.

At block 530 (Generating At Least One Link Loading Attribute Regarding Link based on Preview Information), user device 110 and/or link preview manager 310 may generate at least one link loading attribute regarding the link based on the preview information. In some embodiments, user device 110 and/or link preview manager 310 may determine how to display the at least one link loading attribute based on the preview information and/or at least one device attribute of user device 110 as described with reference to FIG. 2 above. Processing may continue from block 530 to block 540.

At block 540 (Displaying At Least One Link Loading Attribute on Display Unit of User Device), user device 110 and/or display unit 240 may display the at least one link loading attribute. In some examples, the at least one link loading attributed may be displayed as being superimposed on the electronic message that is displayed on display unit 240. In some other examples, the at least one link loading attribute may be represented as a color of the link.

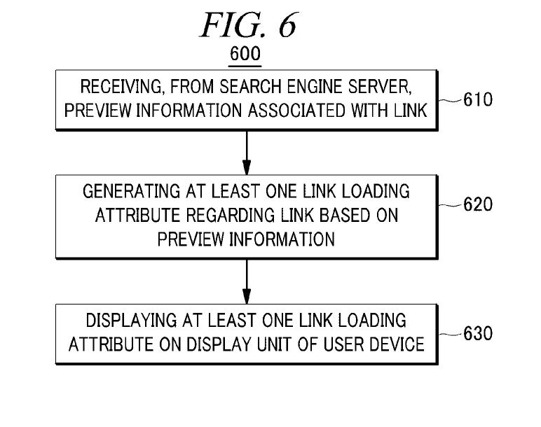

FIG. 6 shows another flow diagram of a process to implement link preview management, arranged in accordance with at least some embodiments described herein.

Process 600 may be implemented in a user device such as user device 110 including at least some of receiving unit 210, link management unit 220, link loading attribute generation unit 230 or display unit 240. Process 600 may also be implemented by computer programs or program modules that may be adapted to provide a link loading attribute generation scheme and hosted by user device 110, such as link preview manager 310 including link management component 410 and link loading attribute generation component 420. Thus reference may be made to the embodiments depicted and described with reference to FIGS. 1-4. Process 600 may include one or more operations, actions, or functions as illustrated by one or more blocks 610, 620 and/or 630. Although illustrated as discrete blocks, various blocks may be divided into additional blocks, combined into fewer blocks, or eliminated, depending on the desired implementation. Processing may begin at block 610.

At block 610 (Receiving, from Search Engine Server, Preview Information associated with Link), user device 110 and/or receiver unit 210 may receive, from a search engine server, preview information associated with a link included in an electronic message. In some examples, the search engine server may be configured to collect the preview information associated with the link and provide the preview information to user device 110. The search engine server may have extracted and calculated the preview information associated with the link beforehand, by, for example, receiving, from a content server, a data file associated with the link; extracting one or more parameters regarding data content associated with the link; and calculating the preview information from the extracted parameters. The search engine server may be configured to transmit, to user device 110, the preview information associated with the link upon receiving a request from user device 110. Processing may continue from block 610 to block 620.

At block 620 (Generating At Least One Link Loading Attribute Regarding Link based on Preview Information), user device 110 and/or link preview manager 310 may generate at least one link loading attribute regarding the link based on the preview information. In some embodiments, user device 110 and/or link preview manager 310 may determine how to display the at least one link loading attribute based the preview information and/or at least one device attribute of user device 110 as described with reference to FIG. 2 above. Processing may continue from block 620 to block 630.

At block 630 (Displaying At Least One Link Loading Attribute on Display Unit of User Device), user device 110 and/or display unit 240 may display the at least one link loading attribute. In some embodiments, the at least one link loading attributed may be displayed as being superimposed on the electronic message that is displayed. In some other examples, the at least one link loading attribute may be represented as a color of the link.

As described regarding FIGS. 5 and 6, the at least one link loading attribute regarding the link may be displayed on the display unit to provide a user of user device 110 with loading information regarding the link. The user may then be able to determine whether or not to access the link with reference to the at least one link loading attribute displayed on display unit 240.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIGS. 7A to 7C show examples that one or more link loading attributes are displayed on a display unit of a user device, arranged in accordance with at least some embodiments described herein. Reference may be made to the embodiments depicted and described with reference to FIGS. 1-4.

FIG. 7A shows a portion of an electronic message displayed on the display unit of the user device. Links 710 and 720 included in the electronic message are also displayed on the display unit, and each of link loading attributes 730 and 740 are located proximate to each of links 710 and 720 on the electronic message, respectively. Each of link loading attributes 730 and 740 may include information regarding content data, which may be downloaded to the user device when the user device connects to, through each of links 710 and 720, a content server associated with each of links 710 and 720.

As depicted in FIG. 7A, the user device may display link loading attributes 730 located proximate to link 710 on the electronic message as a text message. By way of example, but not limitation, link loading attributes 730 may include a total amount of content data associated with link 710 (i.e., “1.3 MB”), an estimated loading time of link 710 (i.e., “ELT: 2.3 sec”), the number of each type of content data (i.e., “7 images, 1 video, 1 JAVA script to install a program”). Further, link loading attributes 740 may include a total amount of content data associated with link 720 (i.e., “2.3 MB”), an estimated loading time of link 720 (i.e., “ELT: 3.1 sec”), the number of each type of content data (i.e., “7 images, 1 video, 1 auto-start audio”).

As depicted in FIG. 7B, the user device may display link loading attributes 750 and 760 as a graphical icon. By way of example, but not limitation, link loading attributes 750 and 760 may include a representative type of content data associated with respective links 710 and 720 (i.e., “T” and “V,” which indicate the representative type as text content and video content, respectively). Further, link loading attributes 750 and 760 may include other graphical icons with, for example, a different color, brightness, darkness, etc. to indicate, for example, a total amount of content data associated with link 710 and 720 or an estimated loading time of link 710 and 720.

In some embodiments, the user device may be operated with a pointing device (such as, for example, a mouse), and the user device may be configured to display at least one link loading attributes when a pointer of the pointing device is moved over a link. As depicted in FIG. 7C, the user device may display link loading attributes 740 when a pointer 770 of the pointing device is moved over link 720.

The examples described with reference FIGS. 7A to 7C are illustrative only, and those skilled in the art would appreciate that other manners of displaying at least one link loading attribute on the display unit of the user device may also be possible. By way of example, but not limitation, when the amount of content data associated with link 710 or 720 is relatively more than others or the estimated loading time associated with link 710 or 720 is relatively longer than others, the color of the link may be changed, for example, from blue to red.

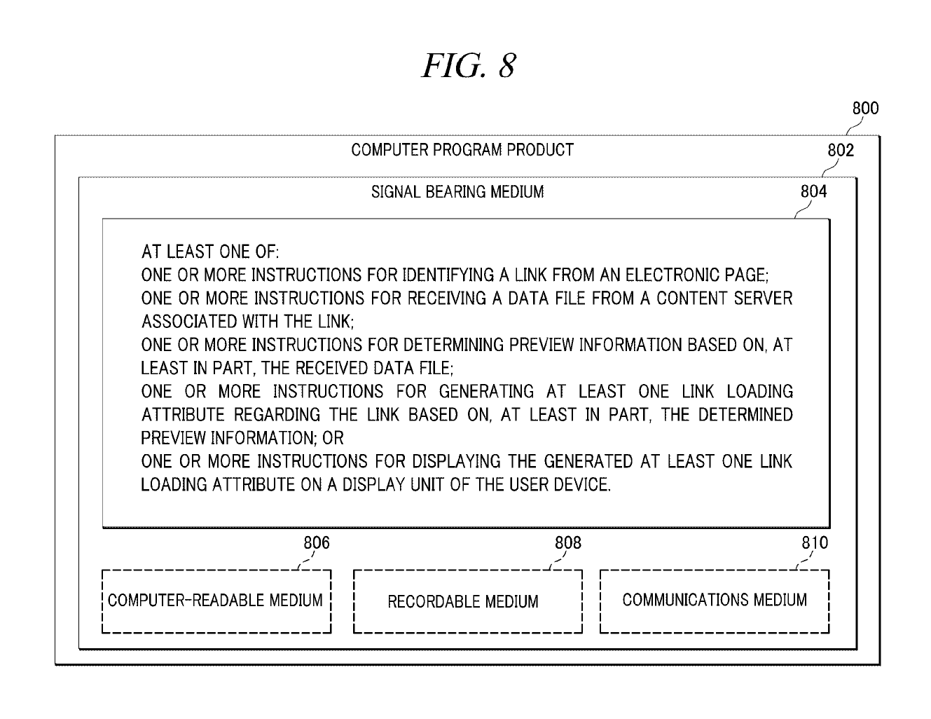

FIG. 8 illustrates an example computer program product 800 that may be utilized to implement link preview management, arranged in accordance with at least some embodiments described herein.

As depicted, program product 800 may include a signal bearing medium 802. Signal bearing medium 802 may include one or more instructions 804 that, when executed by, for example, user device 110 may provide the functionality described above with respect to FIGS. 1-7. By way of example, instructions 804 may include: one or more instructions for identifying a link from an electronic message; one or more instructions for receiving a data file from a content server associated with the link; one or more instructions for determining preview information based on, at least in part, the received data file; one or more instructions for generating at least one link loading attribute regarding the link based on, at least in part, the determined preview information; or one or more instructions for displaying the generated at least one link loading attribute on a display unit of the user device.

In some implementations, signal bearing medium 802 may encompass a computer-readable medium 806, such as, but not limited to, a hard disk drive, a CD, a DVD, a digital tape, memory, etc. In some implementations, signal bearing medium 802 may encompass a recordable medium 808, such as, but not limited to, memory, read/write (R/W) CDs, R/W DVDs, etc. In some implementations, signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, program product 800 may be conveyed to one or more modules of user device 110 by an RF signal bearing medium 802, where the signal bearing medium 802 is conveyed by a wireless communications medium 810 (e.g., a wireless communications medium conforming with the IEEE 802.11 standard).

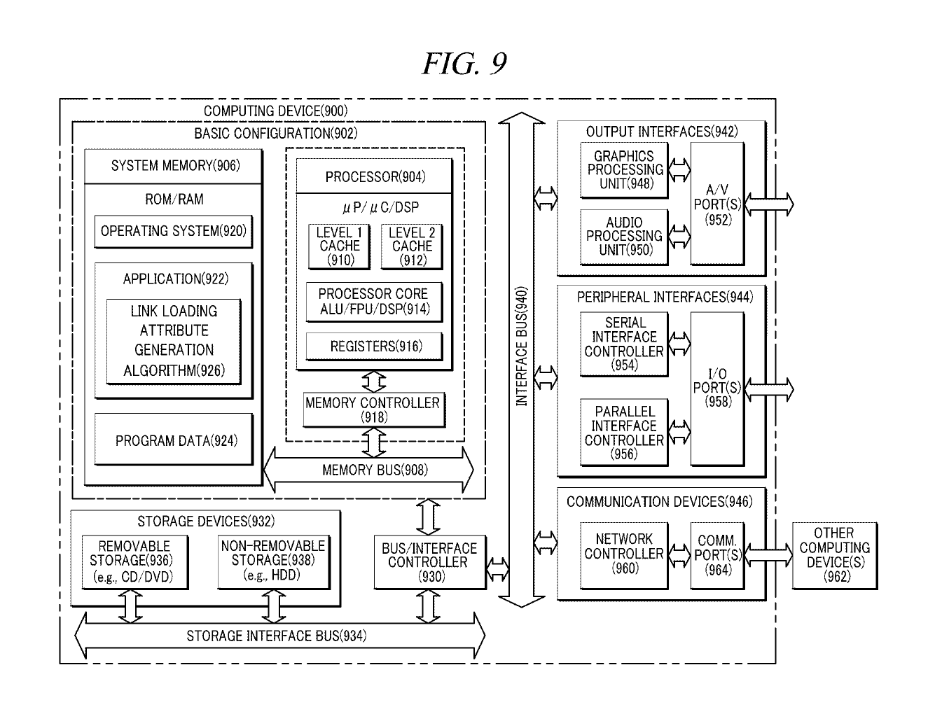

FIG. 9 is a block diagram illustrating an example computing device 900 that may be utilized to implement link preview management, arranged in accordance with at least some embodiments described herein.

In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (μP), a microcontroller (μC), a digital signal processor (DSP), or any combination thereof. Processor 904 may include one or more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof. An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof. System memory 906 may include an operating system 920, one or more applications 922, and program data 924.

Application 922 may include an link loading attribute generation algorithm 926 that may be arranged to perform the functions as described herein including the actions described with respect to user device 110 architectures as shown in FIGS. 2-4 or including the actions described with respect to the flow chart shown in FIGS. 5-6. Program data 924 may include any data that may be useful for providing the advertisement management scheme as is described herein. In some examples, application 922 may be arranged to operate with program data 924 on an operating system 920 such that the link loading attribute generation scheme as described herein may be provided.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more A/V ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method performed under control of a user device, comprising:
obtaining preview information associated with a link included in an electronic message;
generating at least one link loading attribute regarding the link based on, at least in part, the preview information; and
displaying the at least one link loading attribute on a display unit of the user device.

2. The method of claim 1, wherein the electronic message includes at least one of a web page, an e-mail message, an application, or a page of a SNS (Social Network Service).

3. The method of claim 1, wherein the obtaining comprises:
receiving a data file from a content server associated with the link; and
determining the preview information based on, at least in part, the received data file.

4. The method of claim 3, wherein the data file comprises at least one of a HTML (Hyper-Text Mark-up Language) file, a DOM (Document Object Model) file or a JAVA script file.

5. The method of claim 1, wherein the obtaining comprises:
receiving, from a search engine server, the preview information associated with the link.

6. The method of claim 1, wherein the preview information includes information regarding data content associated with the link.

7. The method of claim 6, wherein the data content includes at least one of text data, image data, video data, audio data or program data.

8. The method of claim 6, wherein the information regarding the data content includes at least one of a type of the data content, a number of each type of the data content, or a size of each of the data content.

9. The method of claim 1, wherein the preview information indicates a processing time or a routing time of a content server associated with the link.

10. The method of claim 1, wherein the at least one link loading attribute includes at least one of a total amount of content data associated with the link, an estimated loading time of the link or a representative type of content data associated with the link.

11. The method of claim 1, wherein the generating is further based on at least one device attribute of the user device.

12. The method of claim 11, wherein the at least one device attribute includes at least one of a size of the display unit of the user device or a network connectivity of the user device.

13. The method of claim 1, wherein the displaying comprises displaying the at least one link loading attribute as a text message or a graphical icon.

14. The method of claim 1, wherein the displaying comprises displaying the at least one link loading attribute as being superimposed on the electronic message that is displayed on the display unit of the user device.

15. The method of claim 14, wherein the at least one link loading attribute is located proximate to the link on the electronic message.

16. The method of claim 1, wherein the displaying comprises changing the color of the link to a different color based on, at least in part, the at least one link loading attribute.

17. A user device, comprising:
a receiver unit configured to receive an electronic message;
a link management unit configured to obtain preview information associated with a link included in the received electronic message;
a link loading attribute generation unit configured to generate at least one link loading attribute regarding the link based on, at least in part, the preview information; and
a display unit configured to display the at least one link loading attribute.

18. The user device of claim 17, wherein the electronic message includes at least one of a web page, an e-mail message, an application, or a page of an SNS (Social Network Service).

19. The user device of claim 17, wherein the receiver unit is further configured to receive a data file from a content server associated with the link, and
wherein the link management unit is further configured to determine the preview information based on, at least in part, the received data file.

20. The user device of claim 17, wherein the receiver unit is further configured to receive, from a search engine server, the preview information associated with the link.

21. The user device of claim 17, wherein the preview information includes information regarding data content associated with the link, the data content including at least one of text data, image data, video data, audio data or program data, and
wherein the information regarding the data content includes at least one of a type of the data content, a number of each type of the data content, or a size of each of the data content.

22. The user device of claim 17, wherein the at least one link loading attribute includes at least one of a total amount of content data associated with the link, an estimated loading time of the link or a representative type of content data associated with the link.

23. The user device of claim 17, wherein the display unit is further configured to display the at least one link loading attribute as being superimposed on the electronic message and proximate to the link.

24. A computer-readable storage medium having stored thereon computer-executable instructions that, in response to execution, cause a user device to perform operations, comprising:
identifying a link from an electronic message;
receiving a data file from a content server associated with the link;
determining preview information based on, at least in part, the received data file;
generating at least one link loading attribute regarding the link based on, at least in part, the determined preview information; and
displaying the generated at least one link loading attribute on a display unit of the user device.

25. The computer-readable storage medium of claim 24, wherein the preview information includes information regarding data content associated with the link, the data content including at least one of text data, image data, video data, audio data or program data, and
wherein the information regarding the data content includes at least one of a type of the data content, a number of each type of the data content, or a size of each of the data content.
